(19) United States
(12) Patent Application Publication
(10) Pub. No.: US 2011/0289117 A1
(43) Pub. Date: Nov. 24, 2011

(54) SYSTEMS AND METHODS FOR USER CONTROLLABLE, AUTOMATED RECORDING AND SEARCHING OF COMPUTER ACTIVITY

(75) Inventors: Dakshi Agrawal, Monsey, NY (US); Chatschik Bisdikian, Chappaqua, NY (US); Joel W. Branch, Hamden, CT (US); Vasileios Pappas, Elmsford, NY (US); Ho Yin Starsky Wong, Ossining, NY (US)

(73) Assignee: INTERNATIONAL BUSINESS MACHINES CORPORATION, Armonk, NY (US)

(21) Appl. No.: 12/783,118

(22) Filed: May 19, 2010

(51) Int. Cl. G06F 17/30

(52) U.S. Cl. 707/802; 707/E17.005

(57) ABSTRACT

Systems and methods for automating the process of recording, indexing, and searching computer activity are provided. Events resulting from computer activities trigger capturing of contents and association of operational contextual information to form a searchable record of activities. The searchable record can be stored in local computer for use by its user, or on server computer, such as can be used for a tutorial by multiple users. Storage management can be used to manage the storage requirements of the captured information forming the searchable record.

### FIELD OF THE INVENTION

The subject matter presented herein generally relates to computer activity indexing and searching.

### BACKGROUND

In commonly recurring situations, users of computers encounter difficulty in determining a computer activity needed to accomplish a task. Such difficulty can arise in a variety of different contexts. For example, a user may have difficulty recalling a computer activity that he or she previously undertook to accomplish a task. As another example, consider the case of training users to utilize a new software application.

In the context of a user having difficulty recalling a computer activity that he or she previously undertook to accomplish a task, the user may not recall which sequence of steps and/or parameter settings allowed for configuring a particular feature in a software application, or which sequence of steps he or she followed in accessing a niche web site containing unique information that was not easily discovered (for example, via a search engine) in the first place. Some reasons for this type of difficulty could include an extended period of time passing since the last time the user performed the task in question, the user having someone else (an associate) perform the task, the operating environment having changed since the last time the user performed the task, web-browser caches having been cleared, software having been updated, et cetera. In the context of new software, inexperienced users may not have any sufficient resource to guide them through the use of the new software.

### BRIEF SUMMARY

Embodiments are directed to systems and methods to selectively record and automatically index, according to user preferences, user activities to provide for future querying and retrieving of these activities. Embodiments create a searchable record of computer activities. Embodiments create searchable computer activity recordings that associate multi-modal clues extracted during the recording sessions, such as visuals (screen shot recordings), text and voice commands (entered by user), application events (menu entry selected), operating system (OS) events (mouse position, active window), and so on. The collection, association, and indexing of the various recorded clues of computer activities into a searchable record is done automatically and unobtrusively, that is, without interfering with users' normal use of their computers, hence providing improved user experience and utility.

Embodiments are also directed to systems and methods for controlling storage requirements of the recorded clues, which may be stored either locally on users' computers or remotely, per users' preferences, to be accessed by any number of users, such as in the case for training applications.

In summary, one aspect provides a method comprising: detecting one or more events corresponding to user interaction with an electronic device; capturing screen contents corresponding to the user interaction with the electronic device; capturing operational context metadata associated with the one or more events; and associating the screen contents with the one or more events and the operational context metadata in a searchable record.

Another aspect provides a computer program product comprising: a computer readable storage medium having computer readable program code embodied therewith, the computer readable program code comprising: computer readable program code configured to detect one or more events corresponding to user interaction with an electronic device; computer readable program code configured to capture screen contents corresponding to the user interaction with the electronic device; computer readable program code configured to capture operational context metadata associated with the one or more events; and computer readable program code configured to associate the screen contents with the one or more events and the operational context metadata in a searchable record.

A further aspect provides an apparatus comprising: one or more processors; and one or more modules of executable code; wherein, responsive to execution of the one or more modules of executable code, the one or more processors are configured to: detect one or more events corresponding to user interaction with the apparatus; capture screen contents corresponding to the user interaction with the apparatus; capture operational context metadata associated with the one or more events; and associate the screen contents with the one or more events and the operational context metadata in a searchable record.

The foregoing is a summary. For a better understanding of example embodiments, together with other and further features and advantages thereof, reference is made to the following description, taken in conjunction with the accompanying drawings, and the scope of the invention will be pointed out in the appended claims.

### BRIEF DESCRIPTION OF THE SEVERAL VIEWS OF THE DRAWINGS

FIG. 1 illustrates an example of a user interface of a personal computer.

FIG. 2 illustrates example functional modules.

FIG. 3 illustrates example steps of a method for computer activity recording.

FIG. 4 illustrates example steps of a method for association and indexing computer activity.

FIG. 5 illustrates example use scenarios for recorded computer activity.

FIG. 6 illustrates an example computer system.

### DETAILED DESCRIPTION

It will be readily understood that components of the embodiments, as generally described and illustrated in the figures herein, may be arranged and designed in a wide variety of different configurations in addition to the described example embodiments. Thus, the following more detailed description of embodiments, as represented in the figures, is not intended to limit the scope of the invention, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that various embodiments can be practiced without one or more of the specific details, or with other methods, components, materials, et cetera. In other instances, well-known structures, materials, or operations are not shown or described in detail to avoid obfuscation. Throughout this description, example embodiments are described in connection with a computer, such as a desktop, laptop, or notebook computer; however, those skilled in the art will recognize that certain embodiments are equally applicable to other types of electronic devices.

As described herein, users of computers frequently encounter difficulty in determining how to accomplish a task, such as how to execute a software application function or where and/or how they found a particular web site. Existing solutions do not adequately address such difficulties. For example, using printed literature or help files is often inefficient for learning complex and/or unfamiliar software. Visual support based solutions (for example, short video clips explaining procedures to accomplish certain tasks with the software) can certainly improve the effectiveness of training; however, while one may easily produce such video clips using pre-recorded screen capture sessions, these video clips must be manually indexed into “chapters” to enable the trainee to browse to relevant sections of the recording. Furthermore, such indexing often occurs at coarse granularity, requiring the user to search (if at all possible) through the video using VCR-type controls to find particular operations of interest.

Another commonly used approach to discovering what occurred in a software application is to search through the logs of the application produces. However, these (usually text-based) logs have been designed to support troubleshooting purposes rather than helping forgetful users recall the steps they took to accomplish a task or the steps needed for a new user. The logs are used by IT support people and programmers to discover operational problems, for example, mis-configurations. The logs are not designed to support retracing of user-level desktop activities.

Another established approach is using screen capture tools to record specific user-level operations. However, the screen-capturing sessions recorded by these tools are not searchable, requiring a user to manually annotate or index these sessions, for example, by selection of an appropriate file name for the image file (screen capture), possibly encoding the time and date the recording took place, et cetera. There are screen capture tools that enable text extraction from screen shots, but these approaches fall short in various other respects, such as not providing a process for recalling recorded activity via queries.

Accordingly, embodiments provide easy capturing, indexing, and searching of computer related activities according to a user's preferences. Example embodiments include systems and methods for automating the process of recording, indexing, and searching computer activity. Certain systems and methods use events resulting from desktop activities to trigger capturing the contents of the computer screen and associate these contents with operational contextual information, such as application window focus, menu selections, pop-up messages, input keystrokes, prompt information, operational system generated events, et cetera. Sets of one or more captured screens can be indexed with said associations and stored for future retrieval and searching. A user can control the start, end, and collection of events. The searchable recording can be stored in a local computer for use by its user or on server computer and can be used as a tutorial material by multiple users. Storage management can be used to manage the storage requirements of the captured screens. Accordingly, the example embodiments described herein provide several examples of systems, methods, apparatuses and computer program products that address situations in which a user encounters difficulty in determining a computer activity needed to accomplish a task.

The description now turns to the figures. The illustrated embodiments will be best understood by reference to the figures. The following description is intended only by way of example and simply illustrates certain selected example embodiments representative of the invention, as claimed.

It should be noted that the flowchart and block diagrams in the figures illustrate the architecture, functionality, and operation of possible implementations of systems, apparatuses, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

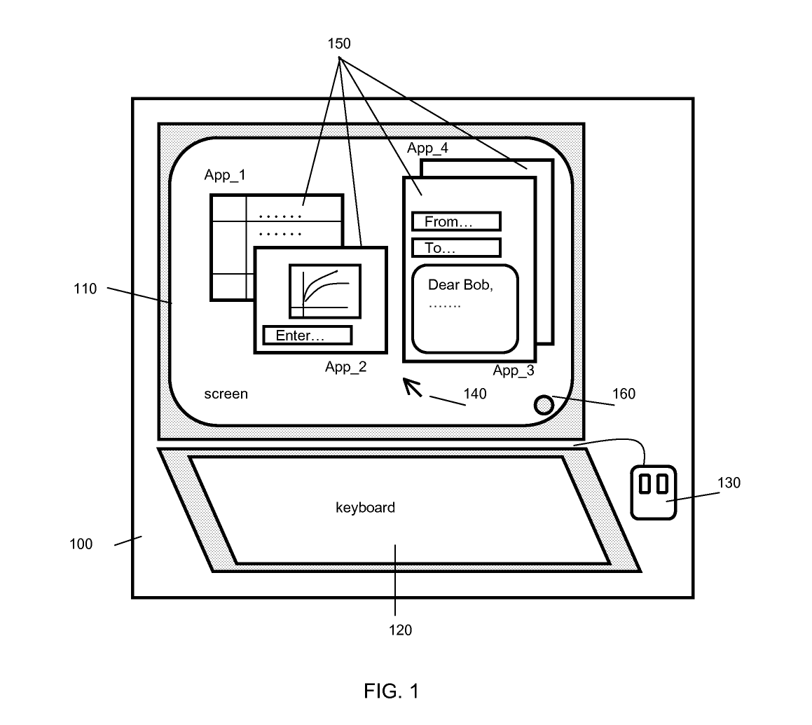

Referring initially to FIG. 1, a representative example of a user interface of a personal computer 100 is illustrated. It includes a computer screen 110, a keyboard 120, and a pointing device (mouse) 130 controlling a pointer 140 on the screen 110. The computer screen 110 shows a number of application windows 150 a user of the computer may interact with. FIG. 1 also shows a visual clue 160 indicating an on-going recording session. In example embodiments, computers may use alternative modalities of interaction with humans such as microphones for accepting voice commands, touch screen displays, speakers for audible responses and narration, and the like.

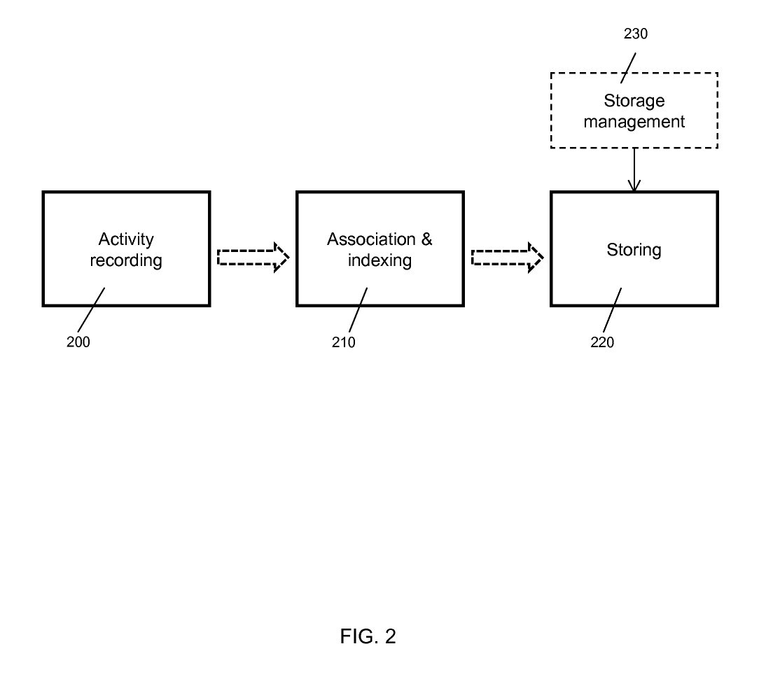

Referring to FIG. 2, examples of functional modules pertinent to certain embodiments are highlighted. An activity recording module 200 concerns itself with recording sets of state and context (for example, operating system (OS) events, screenshots, et cetera) that are the results of user activities. An association and indexing module 210 concerns itself with associating events and activities and indexing them for easy searching in the future. In terms of actually recording events, the dashed arrow between the modules 200 and 210 underscores the dependency that exists between the modules, that is, an association and indexing of events and activities happen in response to these events and activities occurring. However, the dashed arrow does not imply that all activity recording must complete prior to starting association and indexing. Those skilled in the art may choose to implement these modules sequentially in their entirety or overlapping while still maintaining any dependencies that may govern them.

The outcome of association and indexing will be stored by module 220 for future use (that is, retrieval, search, and playback). To control the storage demands of the recording session, certain embodiments may also provide a storage management module 230. Storage scenarios and storage management will be discussed further herein. First, example embodiments concerning the activity recording and association and indexing modules are described.

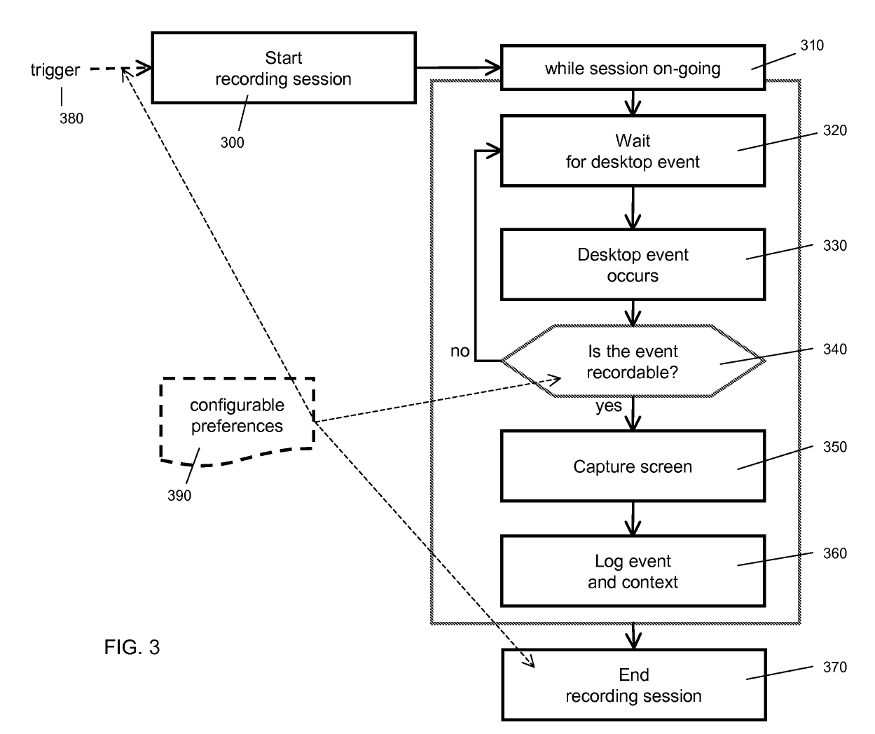

Referring to FIG. 3, example method steps of activity recording 200 are illustrated. After the recording session has started 300 and while is still on-going 310, certain embodiments are configured to wait for a desktop event to occur 320, such as the start of a new application, the selection and clicking on a button in an application window, or the like. In response to such an event 330, a decision is made as to whether the event can be recorded 340. If the event cannot be recorded, certain embodiments are configured to return back to the “wait for desktop event” step. If the event can be recorded, a screen capture (for example, a screenshot) is made 350 to create a visual record of the current desktop activity. To enable smart searches in the future, additional (meta) information is also logged 360 as operational context metadata. This operational context metadata can include application status, such as which action was executed or which menu option was selected, as well as OS events marking, for example, the position of the pointer (140 in FIG. 1), the current active application window, the keyboard entry (if any), et cetera.

The operational context metadata can be intercepted (upon a state change) from the OS in text form and used to annotate the screen contents (screen shots) captured for future searching. For example, a state change occurs when a user clicks the enter button on an application (for example, a web page). These state changes or state events are processed by the OS and can be leveraged for use in annotating corresponding screen shots captured to produce an annotated, searchable record of user activities/operations. These events triggering state changes can be input via a variety of input devices (for example, mouse, keyboard, touch pad, microphone and the like). A human-originated input action (for example, a text input, a voice command, et cetera) can be captured by intercepting these state changes processed by the OS. For example, the text corresponding to a menu selection made by the user can be used to annotate a captured screen shot corresponding to that menu selection operation in an application.

Thus, the operational context pertinent to the user activity is logged and can be used at later time. This additional rich information can be extracted in computer processable and also human readable forms, something over and above that which can be accomplished by only using the visual representations of screenshots. Furthermore, since operational context can be derived even from OS events, the current activity can be recreated in the future automatically. Note that OS events provide much richer context than a mere screenshot, since not everything is necessarily visible on (or computer extractable from) a screenshot, such as whether a particular action was triggered by a mouse click or a keyboard entry, the time and date of the event, et cetera.

Initiating a recording session could happen by an explicit user action, such as switching-on a recording button, but also implicitly through prior configuration. In either case, starting of recording is a triggered action 380. The triggered action can be based on, for example, current operational context, such as the computer user initiated an application that he had a priori configured to be recorded. In step 340, whether an event is recordable can also be configured a priori by the user, for example, events that do not associate to the application currently recorded can be filtered out. Furthermore, certain actions may not be recordable, for example, a password entry, or other personal information may be excluded from being recorded, and/or be blurred out on the screenshot. Stopping a recording 370 could again be done by an explicit user action, or implicitly using a configurable stopping rule, such as stop recording after 10 minutes, or when terminating an application, or following a specific action with an application, et cetera. Therefore, in example embodiments, starting recording, selecting recordable events, and stopping recording can be configured by users through preferences entries 390.

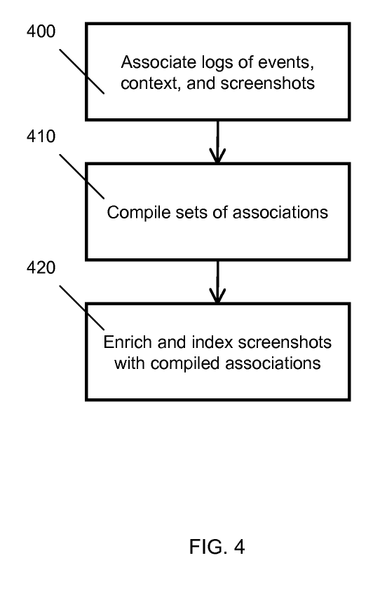

Referring to FIG. 4, example association and index operations (210 in FIG. 2) are described. The purpose of these operations is to enrich screenshots with searchable metadata that can be used by a user to recall appropriate screenshots and screenshot sequences of past recorded activities of interest. These operations include, for example, the association 400 of the logs of events, context and screenshots earlier recorded (steps 350 and 360 in FIG. 3). This association relates screenshots with corresponding operational context (active windows, keystrokes, mouse position and action, menu entries selected, voice commands, et cetera), using appropriate linkages between them such as the proximity of timestamp values in the logs of the previously created logs.

Following the association 400 of individual screenshots with contextual information, certain embodiments will compile 410 sets, such as sequences, of associated screenshots to bigger recorded themes describing an entire activity or sub-activity, such as configuring application A or configuring mode M of application A. This is analogous to a regular video recording, which comprises recorded scenes, and each scene comprises a sequence of video frames; a compilation is to an association what a scene is to a frame. Finally, the entire collection of associations and compiled associations can be used to enrich 420, that is annotate, screenshots, which can then be indexed for future use. For the purpose of future searches of enriched activity screenshots, certain embodiments may store the associations in flat files, database tables, spreadsheets, et cetera.

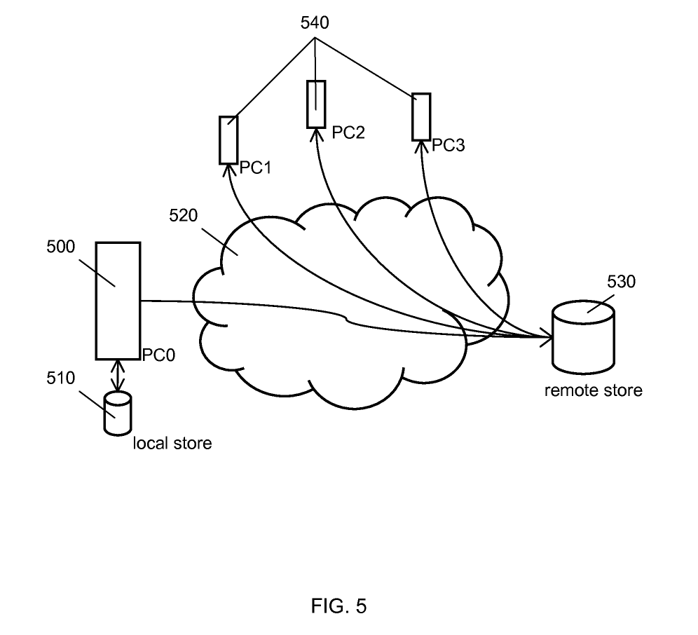

Referring to FIG. 5, example alternative storage and deployment scenarios for an activity recording system are shown. FIG. 5 shows two such scenarios, which are referred to herein as the personal and tutorial scenarios. In the personal scenario, the entire process, described by modules 200 and 210 in FIG. 2, takes place on a user's personal computer 500 and the searchable outcome of the desktop activity is also stored to and retrieved from a local store 510, such as the computer's hard drive.

In the tutorial mode, the searchable outcome of the desktop activity is stored to and retrieved from a remote store 530 that is accessible over a communications network 520. This set-up is particularly amenable for distributing richly annotated and searchable tutorials. These can be developed by an instructor or trainer that records her tutorial desktop activity on her personal computer PCO and stores its searchable outcome on the remote store 530. Then, multiple students or trainees can use their own computers PC1, PC2, . . . , to access, retrieve, and search through the tutorial material.

A typical screenshot of a desktop can be on the order of a few hundred KBs to a few MBs. Hence, a typical hard drive of a personal computer can hold tens to hundreds of thousands of screenshots of desktop activities. This number is large enough to support recordings from a very large number of tutorial recording sessions. However, a personal recording session could last for a very long time, since a user may configure it to run for days or weeks (or more) at a time. In this case, the use of storage management (230 in FIG. 2) to judiciously store screenshots to save storage space might be warranted.

Storage management can be accomplished by taking advantage of the same contextual parameters collected during activity recording. Thus, instead of taking a screenshot of an entire desktop, only a screenshot of the current active window may be taken. In addition, one may focus information (like, where the mouse has last clicked, or which input field on the screen the keystrokes were directed to) to keep a higher quality screenshot only in the vicinity of the focus area and keep a lower quality screenshot for the rest of the window. In such a case where only the screenshot of the immediate focus area is maintained, the storage demand can drop to a few tens of KB at most, increasing stored capacity by at least an order of magnitude. Storage can be further controlled by using incremental storing taking advantage of the fact that the contents of an application window in a screenshot will most of the time include identical contents of the subsequent window, except for changes around the focus area.

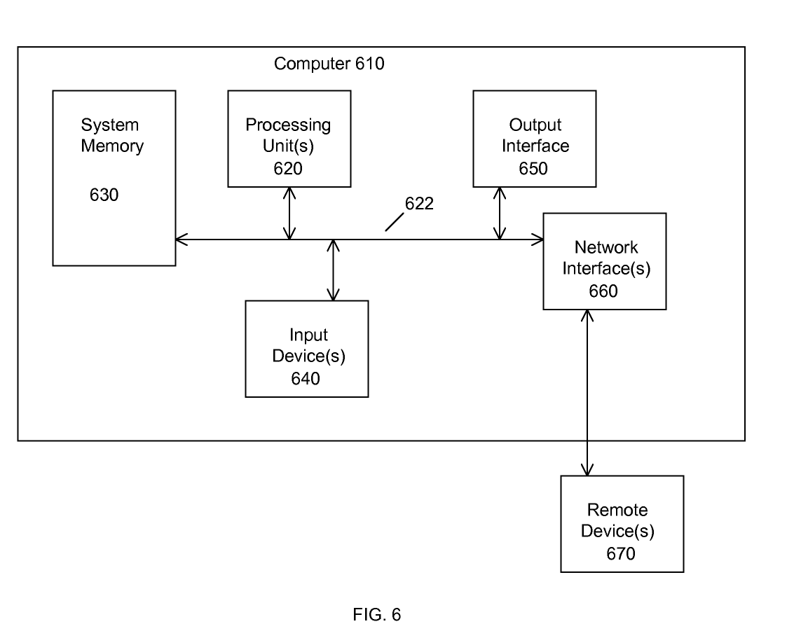

Referring to FIG. 6, it will be readily understood that certain embodiments can be implemented using any of a wide variety of devices. An example device that may be used in implementing one or more embodiments includes a computing device in the form of a computer 610. In this regard, the computer 610 may execute program instructions configured to record computer activities of a user and perform other functionality of the example embodiments, as described herein.

Components of computer 610 may include, but are not limited to, a processing unit 620, a system memory 630, and a system bus 622 that couples various system components including the system memory 630 to the processing unit 620. Computer 610 may include or have access to a variety of computer readable media. The system memory 630 may include computer readable storage media in the form of volatile and/or nonvolatile memory such as read only memory (ROM) and/or random access memory (RAM). By way of example, and not limitation, system memory 630 may also include an OS, application programs, other program modules, and program data.

A user can interface with the computer 610 (for example, enter commands and information) through input devices 640. A monitor or other type of device can also be connected to the system bus 622 via an interface, such as an output interface 650. In addition to a monitor, computers may also include other peripheral output devices. The computer 610 may operate in a networked or distributed environment using logical connections to one or more other remote computers or databases, such as databases storing recorded information of one or more recording sessions. The logical connections may include a network, such as a local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
detecting one or more events corresponding to user interaction with an electronic device;
capturing screen contents corresponding to the user interaction with the electronic device;
capturing operational context metadata associated with the one or more events; and
associating the screen contents with the one or more events and the operational context metadata in a searchable record.

2. The method according to claim 1, wherein the one or more events include one or more user interactions with an application running on the electronic device.

3. The method according to claim 1, wherein the operational context metadata further comprises one or more of: changes in application window focus, one or more menu selections, one or more pop-up messages, one or more input key strokes, prompt information, and operating system generated events.

4. The method according to claim 1, wherein the one or more events comprise a plurality of events grouped together as a set.

5. The method according to claim 4, wherein the searchable record comprises information indexed according to the set.

6. The method according to claim 1, further comprising applying one or more user preferences, the one or more user preferences including one or more of: an indication of a start time for detecting the one or more events; one or more event types to be detected, one or more event types to exclude from detection, and an indication of a stop time for detecting the one or more events.

7. The method according to claim 1, further comprising storing the searchable record.

8. The method according to claim 7, wherein storing the searchable record includes one or more of storing the searchable record on the electronic device and storing the searchable record on a remote electronic device operatively connected to the electronic device.

9. The method according to claim 7, further comprising employing one or more manipulations to reduce an amount of information stored in the searchable record, the one or more manipulations including one or more of using focus areas for capturing the one or more screen contents, and employing incremental storing.

10. The method according to claim 1, further comprising displaying on a display device of the electronic device a user perceivable indication of an ongoing recording session.

11. A computer program product comprising:
a computer readable storage medium having computer readable program code embodied therewith, the computer readable program code comprising:
computer readable program code configured to detect one or more events corresponding to user interaction with an electronic device;
computer readable program code configured to capture screen contents corresponding to the user interaction with the electronic device;
computer readable program code configured to capture operational context metadata associated with the one or more events; and
computer readable program code configured to associate the screen contents with the one or more events and the operational context metadata in a searchable record.

12. The computer program product according to claim 11, wherein the one or more events include one or more user interactions with an application running on the electronic device.

13. The computer program product according to claim 11, wherein the operational context metadata further comprises one or more of: changes in application window focus, one or more menu selections, one or more pop-up messages, one or more input key strokes, prompt information, and operating system generated events.

14. The computer program product according to claim 11, wherein the one or more events comprise a plurality of events grouped together as a set.

15. The computer program product according to claim 14, wherein the searchable record comprises information indexed according to the set.

16. The computer program product according to claim 11, further comprising computer readable program code configured to apply one or more user preferences, the one or more user preferences including one or more of: an indication of a start time for detecting the one or more events; one or more event types to be detected, one or more event types to exclude from detection, and an indication of a stop time for detecting the one or more events.

17. The computer program product according to claim 11, further comprising computer readable program code configured to store the searchable record.

18. The computer program product according to claim 17, further comprising computer readable program code configured to employ one or more manipulations to reduce an amount of information stored in the searchable record, the one or more manipulations including one or more of using focus areas for capturing the one or more screen contents, and employing incremental storing.

19. The computer program product according to claim 11, further comprising computer readable program code configured to display on a display device of the electronic device a user perceivable indication of an ongoing recording session.

20. An apparatus comprising:
one or more processors; and
one or more modules of executable code;
wherein, responsive to execution of the one or more modules of executable code, the one or more processors are configured to:
detect one or more events corresponding to user interaction with the apparatus;
capture screen contents corresponding to the user interaction with the apparatus;
capture operational context metadata associated with the one or more events; and
associate the screen contents with the one or more events and the operational context metadata in a searchable record.
